(19) United States
(12) Patent Application Publication
(10) Pub. No.: US 2011/0115191 A1
(43) Pub. Date: May 19, 2011

(54) TALL BIKE AND FRAME

(76) Inventor: Joseph VanLoozen, Levering, MI (US)

(21) Appl. No.: 12/621,089

(22) Filed: Nov. 18, 2009

(51) Int. Cl. B62K 3/04

(52) U.S. Cl. 280/274

(57) ABSTRACT

A bicycle frame for a tall bike and a tall bike using the frame are disclosed. The frame includes an upwardly-tilted quadrilateral front frame portion, and a triangular rear portion sharing a common seat tube with the quadrilateral frame portion. The seat tube defines the forward leg of the rear triangle and the rearmost leg of the quadrilateral, and most or all of the seat tube is located forwardly of a radially forward-most point of a rear wheel mounted to the rear of the triangular frame portion. A crankset is mounted on an upper part of the seat tube below the top tube and above the down tube, also vertically forward of the rear wheel. The frame provides improved balance and stability and strength for a tall bike.

### RELATED APPLICATIONS/PRIORITY BENEFIT CLAIM

There is a co-pending U.S. design patent application by the same inventor, filed on the same date, attorney docket number VAN-002-D.

### FIELD

The subject matter of the present application is in the field of bicycles, and in particular in the field of so-called “tall bikes” with non-horizontal chain drives that elevate the rider higher than a normal bicycle.

### BACKGROUND AND DESCRIPTION OF RELATED ART

Relatively high-framed or “tall” bikes have apparently been known since the early days of bicycling. Tall bikes have non-horizontal chain drives, with a crankset higher than the rear wheel sprocket, so that a person seated relatively high off the ground can drive the rear wheel using the pedals on the crankset. For example, the men who lit gas-burning streetlamps at night in the nineteenth century are reported to have used tall bikes with non-horizontal chain drives on their nightly rounds, lighting lamps elevated a dozen or more feet off the ground. Early tall bikes used for work purposes, such as the lamplighter bikes, were large and heavy and a rider apparently needed assistance or a ladder to get on and off.

Modern tall bikes are generally used for fun and recreation; and, also, because some riders prefer the greater visibility that being seated two or three fee higher off the ground provides, both for the rider and for nearby drivers. Modern tall bikes are believed to be typically built by either welding two bike frames stacked on top of each other, one rightside-up and one upside-down, or by turning a conventional bike frame upside-down and adding an elongated head tube/handlebar set and an elongated seatpost tube.

One known problem with tall bikes is lack of balance. The seat tends to line up with or behind the rear wheel axle, creating a tendency for the front wheel to have little weight on it and to lift off the ground, especially when mounting and when accelerating. Attempts to address this problem have included moving the seatpost forward, lowering the front handlebars, and/or using a smaller front wheel. These one-off attempts to fix balance issues by accommodating the typical tall bike frame construction are believed to have been generally awkward and not particularly effective

The above-mentioned solutions to the front wheel balance problem also fail to address another issue with tall bikes, namely frame strength and long term durability. Simply using thicker tubing for the frame would increase strength, but adds to a tall bike's already increased weight in a manner that most recreational users would find unmanageable or unwieldy. And even if thicker tubing were used, the number and placement of welded joints in prior tall bike frames creates weak points, resulting in a higher likelihood of cracking and corrosion.

### BRIEF SUMMARY

I have invented a new frame for a non-horizontal chain drive bicycle, i.e. a “tall bike”. A tall bike with such a frame has better balance and more strength than conventional tall bike frames, and is easier to ride, mount and dismount.

The tall bike frame comprises a tilted quadrilateral main frame portion comprising a rearwardly-angled head tube, a rearwardly-angled seat tube, an upwardly-angled top tube, and an upwardly-angled down tube. The tall bike frame also comprises triangular rear frame portion comprising the seat tube, a seat stay, and a chain stay, in which the chain stay forming the base of the triangle has an angle from horizontal optionally less than the angle of the down tube. The frame has a crankset attachment point on an intermediate span of the seat tube between the top tube and down tube, such that a crankset mounted on the frame is supported by the triangular rear frame at a location both above the rear wheel axis and forward of a rear wheel connected to the triangular rear frame portion. In a further form the seat tube and head tube are parallel. In a further form the top tube and the seat stay are aligned and at the same angle.

In a further form, a seatpost extends from the seat tube above the quadrilateral main frame. In a further form, the seat tube terminates at a point lower than the upper end of the head tube (which is adapted to support handlebars), so that any mounted handlebars are higher than any mounted seat. In a further form, the upper part of the seatpost terminates forwardly of a rear wheel attachment point at the rear vertex of the triangular rear frame, so that the center of balance of a seat mounted on the end of the seatpost would be located forward of the rear wheel axis. The seatpost may or may not include an extensible or telescoping adjustable portion or tube insert, and may or may not be an integral extension or continuation of the lower part of the seat tube.

In a further form, the angles of the head tube and seat tube/seatpost are less than 25° from vertical, further improving stability.

In a tall bike using the frame, the seat tube (defining the forward leg of the triangular rear frame) has an upper end located forward of the radially forward-most tangential point or “edge” of the rear wheel, and rearward of the down tube, and the crankset is mounted on the upper end of the seat tube at a location forward of the forward “edge” of the rear wheel and rearward of the down tube. The upper end of the seat post is located forwardly of the rear wheel attachment point on the triangular frame, so that the point of balance of a seat mounted on the seat post is also located forward of the rear wheel attachment point (the axis of the rear wheel).

In still a further form, the chain and the seat stays are forked or diverge or otherwise provide an opening or path at some point between the seat tube and the rear wheel axis, and the path of the chain from the crankset on the seat tube to the rear wheel passes between or through the diverging arms of both the chain and seat stays between the seat tube and the rear wheel attachment or axis. The chain thus effectively crosses or intersects the axis of the seat stay and of the chain stay on its way to and from the rear sprocket.

These and other features and advantages of the bike frame and of a tall bike employing the frame will become apparent from the detailed description below, in light of the accompanying drawings.

### BRIEF DESCRIPTION OF THE DRAWINGS

FIG. 1 is a right side view of a tall bike with a bike frame according to the inventive subject matter.

FIG. 1A illustrates the bike frame from FIG. 1, but a quadrilateral forward portion of the frame is called out in solid lines with the remainder of the bike in phantom lines.

FIG. 1B is similar to FIG. 1A, but a triangular rear portion of the frame is called out in solid lines with the remainder of the bike in phantom.

FIG. 2 is a left side view of the tall bike of FIG. 1.

FIG. 3 is a front perspective view of a detail of the bike frame of FIG. 1.

FIG. 4 shows a rider in an initial stage of mounting the tall bike of FIG. 1.

FIG. 5 shows a rider in an intermediate stage of mounting the tall bike of FIG. 1.

FIG. 6 shows the rider riding the tall bike of FIG. 1.

### DETAILED DESCRIPTION

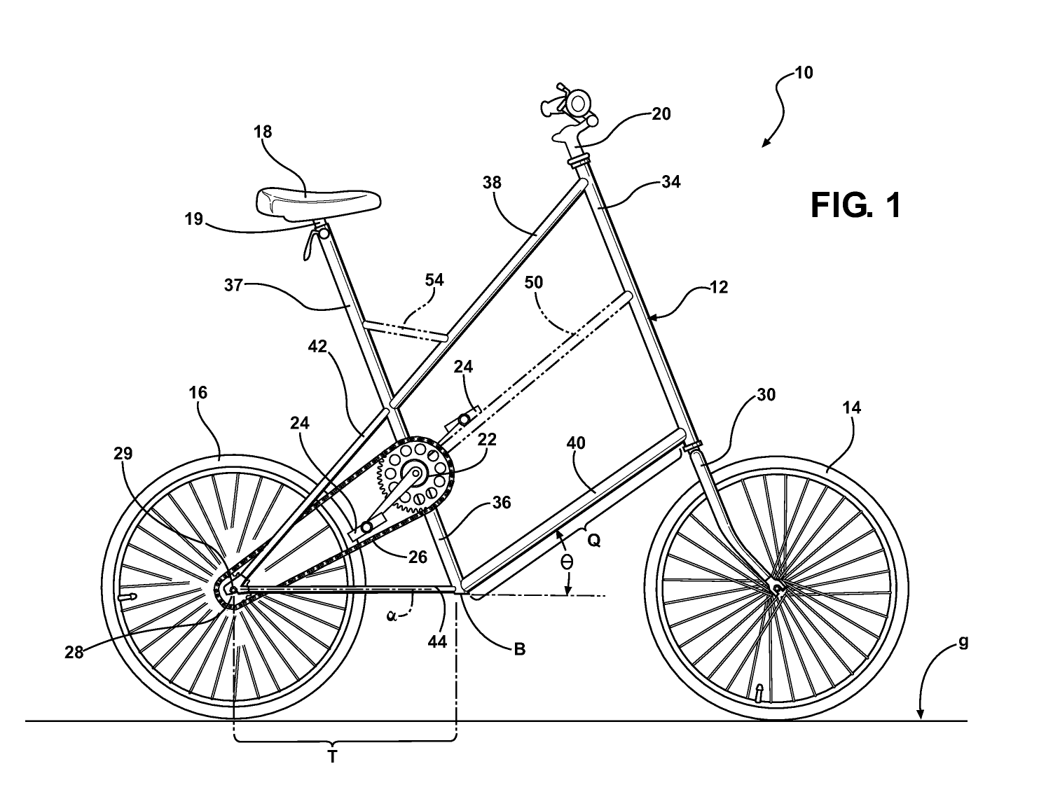

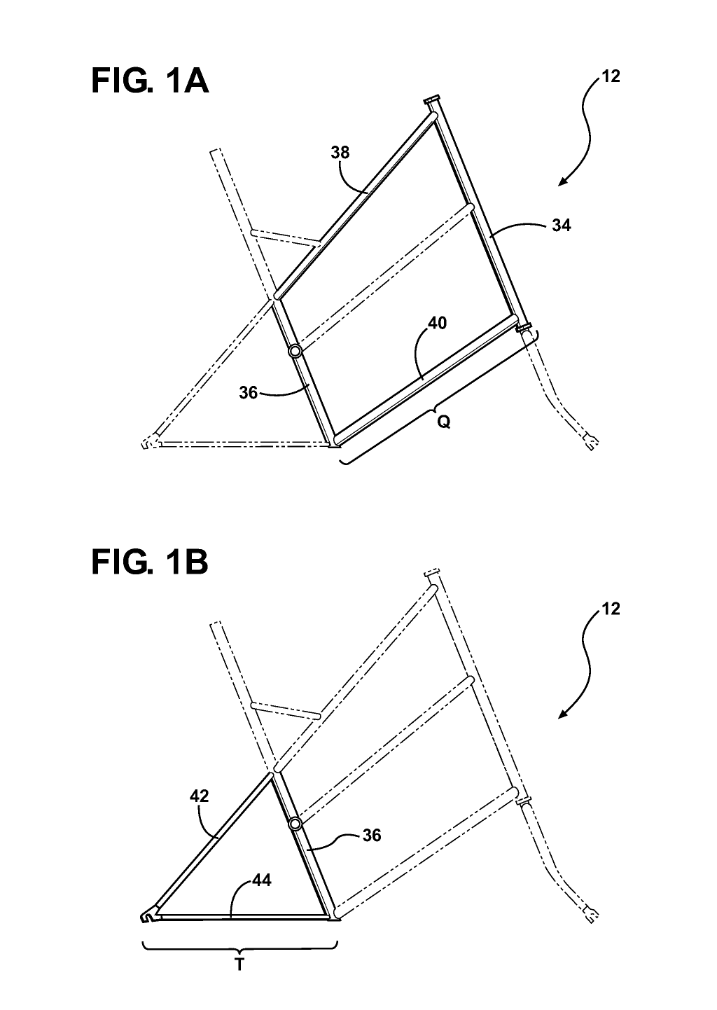

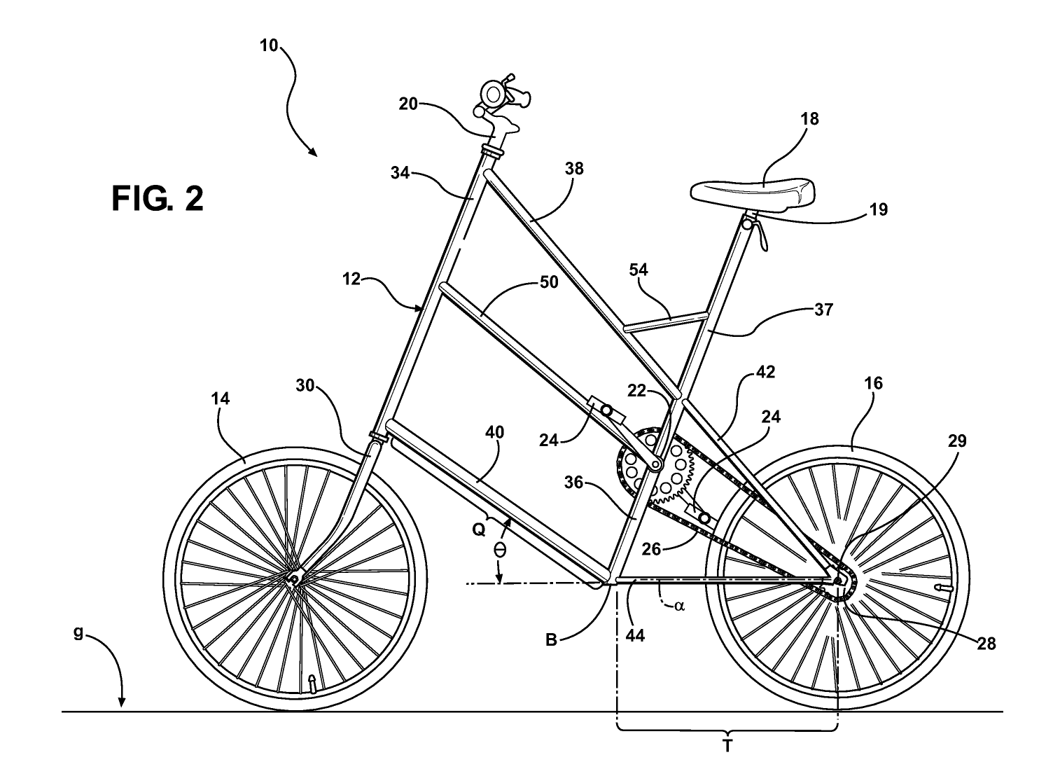

Referring first to FIGS. 1 through 3, a tall bike 10 with a frame 12 according to the claimed invention is shown in exemplary form in order to teach how to make and use claimed subject matter.

Frame 12 is shown provided with parts mounted to form a bicycle: front wheel 14, rear wheel 16, a seat 18, a handlebar set 20, a crankset 22 (with foot pedals 24) for driving a chain 26 mounted around a rear sprocket or cassette 28 (depending on the gearing arrangement) connected to rotate with the rear wheel, and a front fork assembly 30. Various other features common to and useful on bicycles are generally omitted or unnumbered, such as brakes, gear shift levers, control cables, a kickstand and the like, since they are not necessary for an understanding and description of the claimed invention, being well known in the field of bicycles. It will further be understood that the foregoing parts mounted on frame 12 to form a tall bike, whether shown and numbered or not, are merely representative of the many variations known, available and/or possible.

Frame 12 has a forward quadrilateral portion Q comprising frame members in the form of a head tube 34, seat tube 36, top tube 38, and down tube 40. By “tube” is meant any hollow, non-hollow, cylindrical, non-cylindrical, or other frame member shape and cross-section capable of functioning as a structural member or portion of a bike frame. In the illustrated example the frame members are formed from steel or aluminum tubing in various sizes, the tubing having a hollow, generally cylindrical cross-section, the tubing connected by welding to form the illustrated frame. Other joining techniques for the frame members may used, including but not limited to mechanical or structural-adhesive connections, and the frame 12 may also be formed from a single piece of material, for example by casting or molding or stamping or other techniques. Also, other metals and non-metal materials may be used for frame 12.

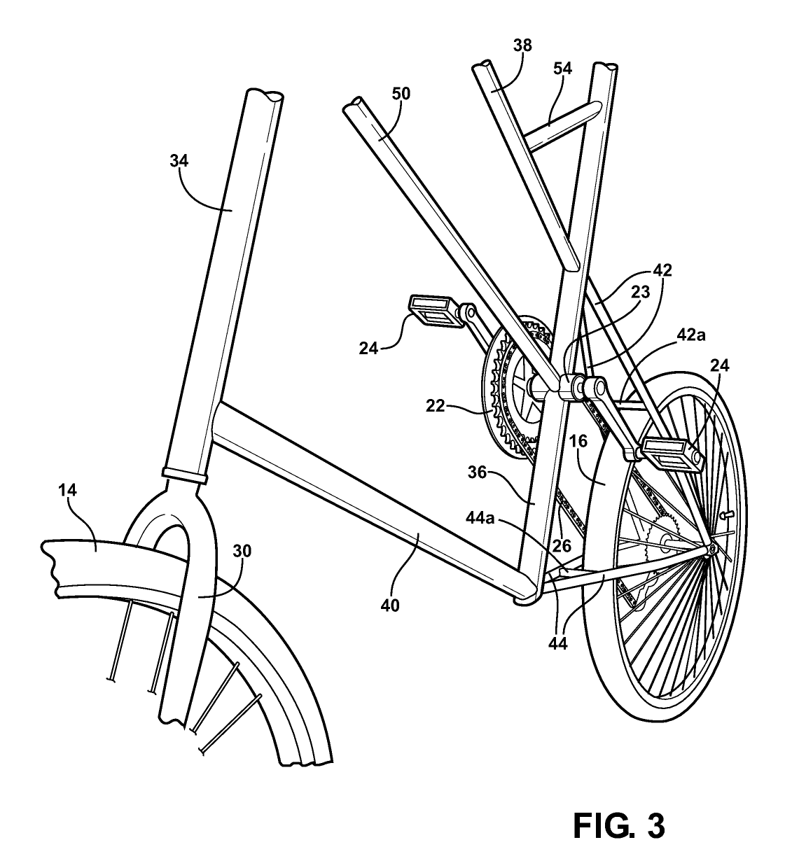

Frame 12 also has a rear triangular portion T comprising the seat tube 36, a seat stay 42, and a chain stay 44. Seat stay 42 and chain stay 44 are illustrated as split or forked structures, each comprising over at least part of their lengths a pair of arms or tubes diverging from seat tube 36 toward the rear of triangular frame portion T to provide a path or opening for chain 26 to to pass through or cross both the chain and seat stays as it drives the rear wheel. Rear wheel 16 may be mounted on a known type of rear wheel attachment point 29 located at the rear “vertex” of frame portion T such as an axle 29a secured to the frame and supporting sprocket 28, as illustrated or in some other fashion. It may be possible to form one or both of seat stay 42 and chain stay 44 as a single member along some or all of their respective lengths, without departing from the scope of the claimed invention, although an opening or passage or guide would be provided in or mounted on the stays to permit the chain to “cross” the stays (either through them or to one side) without interference. The chain and/or seat stays may be formed from tubing of the same or different diameter or thickness, with respect to one another and/or with respect to other portions of frame 12; their diverging arm portions may also be reinforced, for example as best seen in FIG. 3 with short cross-pieces 42a and 44a located forward of rear wheel 16.

Quadrilateral frame portion Q is visually highlighted in FIG. 1A, and triangular frame portion T is visually highlighted in FIG. 1B. Frame portion Q is “tilted” or upswept rear-to-front at an acute angle, the tilt referring to the upward angle θ of the down tube from horizontal as it extends forwardly from bottom bracket B, and the similar or greater upward angle of the top tube 38, such that the junction of top tube 38 and rearwardly-angled head tube 34 is the highest part or apex of the frame portion Q relative to the ground g when the frame is upright as in the Figures.

Triangular frame portion T is “tilted” less so than frame portion Q, referring to the angle α of the chain stay 44 (which forms the base of the rear triangle T) relative to horizontal. The chain stay 44 angle preferably ranges from substantially horizontal, i.e. substantially parallel to the ground g, to some angle α above horizontal less than angle θ of down tube 40. Also, seat tube 36 forming the forward-most leg of the triangular frame portion T lies vertically rearwardly of down tube 40 (i.e., a line drawn to the ground g vertically from any point on seat tube 36 when the frame is upright would not cross down tube 40).

Head tube 34 and seat tube 36 (and also preferably seatpost 37) are substantially in parallel with one another; i.e., they are set at the same rearward angle relative to vertical.

Top tube 38 and seat stay 42 are illustrated in an aligned relationship, at the same upward angle relative to horizontal going from the rear of the bike forward, and forming a straight line when viewed from the side of the bike. This creates a preferred straight structural member for the transfer of forces from the apex of frame 12 at the handlebars to the rear wheel attachment 29 at the rear vertex of triangle T.

Frame 12, and specifically the quadrilateral forward portion Q of the frame, optionally includes a mid-tube 50 running from an intermediate location on seat tube 36 to an intermediate location on head tube 34, primarily for ornamention in what I refer to as a “sunburst” design with members 40, 50, and 38 diverging relative to seat tube 36 (subject of the previously mentioned co-pending U.S. design patent application). Mid-tube 50 can also optionally add strength to the frame portion Q, above down tube 40 and below top tube 38, with various shapes and/or locations and/or angles relative to down tube 40 and top tube 38. Mid-tube 50 may be (and for the “sunburst” ornamentation is) a straight tube as shown in the illustrated example, but may alternately be non-straight.

A seatpost 37 extends or continues from seat tube 36 above the top tube 38. While seatpost 37 may be an integral extension of seat tube 36 as in the illustrated example, i.e. they are formed from a single piece of tubing, seatpost 37 may take other forms including but not limited to a fixed non-integral extension of seat tube 36 or an adjustable non-integral extension of seat tube 36. The upper end of seatpost 37 may additionally include a height-adjustable portion such as 19 which may mount a separate seat 18 or which may be part of a separate seat 18 that mates with seatpost 37.

A downwardly-angled brace such as 54 may be connected between the seat post 37 and top tube 38 for additional ornamentation, and optionally for strength depending on the height and strength of the seatpost The straight shape of brace 54 and its angle relative to 38 and 36 is also considered ornamental and is shown in the co-pending design patent application.

Crankset 22 is mounted at a crankset attachment point 23 on seat tube 36, at a location below the intersection or junction of top tube 38 and seat tube 36 (below the “apex” of the triangular frame portion T where 36 and 42 meet) and above the intersection or junction of down tube 40 and seat tube 36. Further, most or all of seat tube 36 lies forwardly of a vertical tangent from the forward-most radial point or “edge” of rear wheel 16 if a rear wheel is mounted on frame 12. Crankset 22 and crankset attachment point 23 are also thus located on an upper part of seat tube 36 at a location vertically forward of rear wheel 16. If quadrilateral forward frame portion Q includes a midtube such as 50, crankset 22 and attachment point 23 may be located on seat tube 36 at or above the intersection or junction of midtube 50 with seat tube 36, as illustrated. The illustrated examples of crankset 22 and crankset attachment point or mount 23 are known, common forms of a tubular attachment socket or crank bearing assembly 23 formed in or on the seat tube 36, and a simple, fixed gear style of crankset 22. The structure, type, and/or style of crankset attachment point 23 and of crankset 22 may vary from those examples shown in the drawings, and may include more complex structures for bikes with multiple gears.

Angles of the head tube and seat tube/seatpost are approximately 22° (degrees) from vertical, and are generally tilted rearward from vertical toward the rear of the bike at an angle of less than 25° (degrees).

### DESCRIPTION OF OPERATION

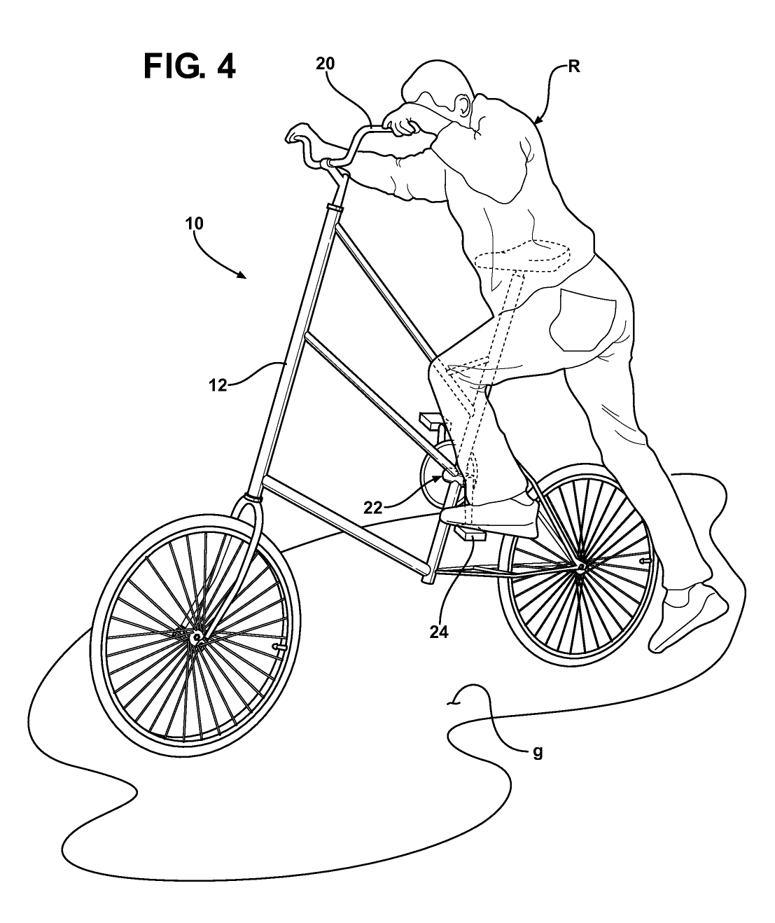

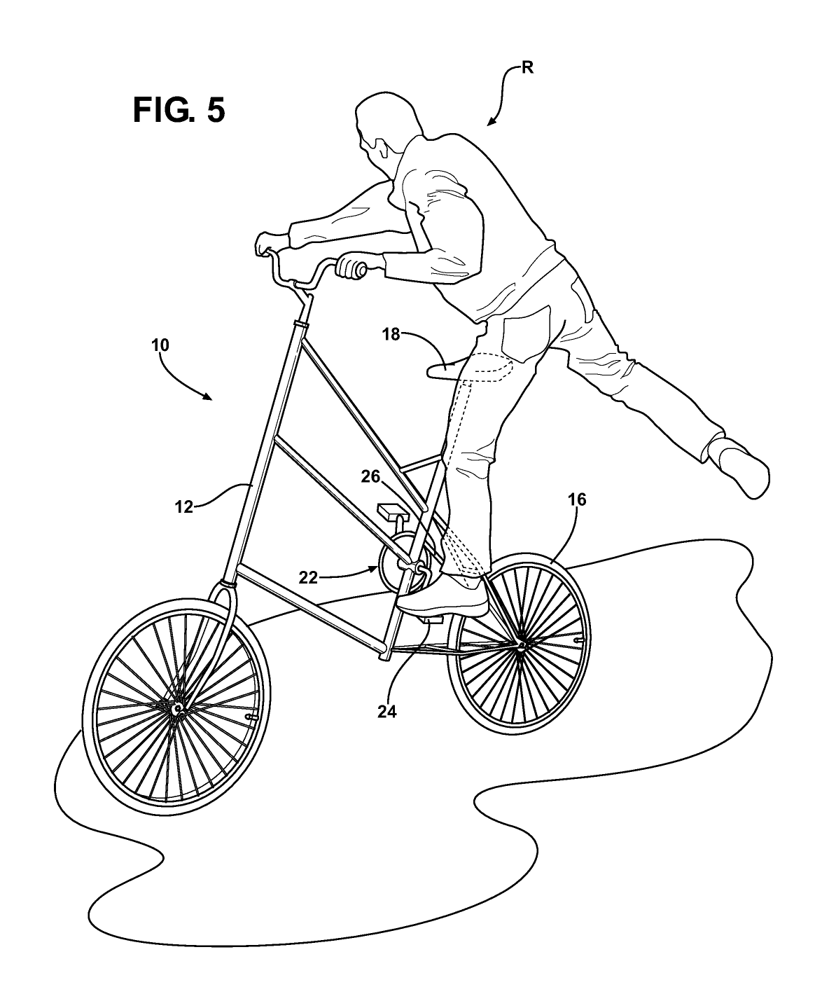

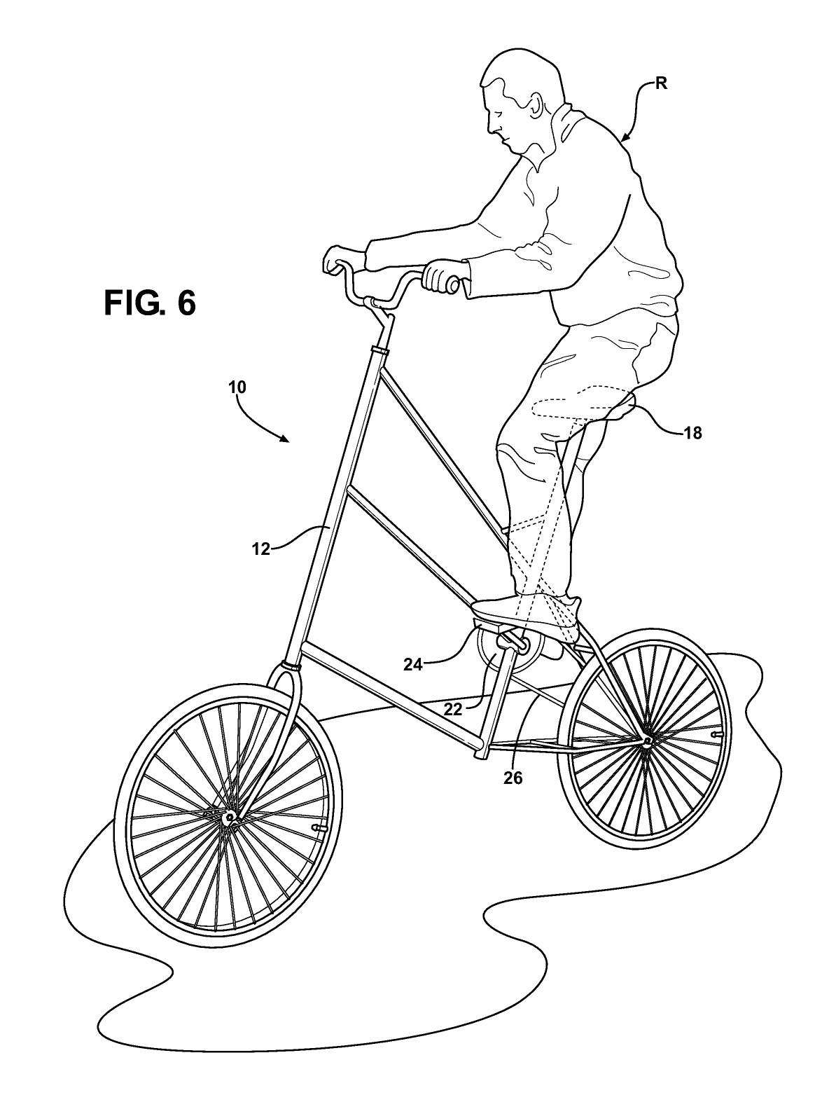

In operation, a tall bike 10 built using a frame 12 according to the claimed invention can be used as illustrated in FIGS. 4 through 6. In FIG. 4, a rider R is beginning to mount tall bike 10, with both hands on the handlebars 20, one foot on a same-side pedal 24 of the crankset 22, and the other foot on the ground for balance while the bike is stationary. In FIG. 5 the rider R has shifted most or all of his weight onto the one leg and foot on the crankset by giving an initial push with his other, grounded foot, and then lifting his other foot off the ground and beginning to swing the other leg and foot up over the rear wheel 16 and seat 18. This begins rotation of the crankset 22, and thus the chain 26 and the bike as a whole. In FIG. 6, rider R has swung his right leg over and around the seat, has seated himself, and placed his right foot on the opposite pedal of the crankset. Tall bike 10 can now be ridden like a regular bicycle. Despite the increased height of frame 12 and rider R, the balance of tall bike 10 throughout the mounting procedure, during riding, and during a dismount (which is achieved by reversing the order of the mounting steps of FIGS. 4 through 6), remains similar to that of a regular bicycle, with weight distributed more or less evenly between the front and rear wheels 14 and 16 except that a rider should be prepared to dismount once the bike stops moving.

In the preceding description, various aspects and examples and configurations of making and using claimed subject matter have been described, for purposes of explanation, to provide a thorough understanding of claimed subject matter, and to enable those skilled in the art to make and use claimed subject matter. However, these are merely example illustrations and descriptions of concepts wherein other illustrations may apply as well, and the scope of claimed subject matter is not limited in these respects. It should be apparent to one skilled in the art having the benefit of this disclosure that claimed subject matter may be practiced without being limited to the specific details of the disclosure. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of invention as reflected in the preceding disclosure and appended claims. It should further be understood that to the extent the term “invention” is used in the written specification, it is not to be construed as a limiting term as to number or type of claimed or disclosed inventions or the scope of any such invention, and does not exclude discoveries or designs; rather, it is a term which has long been conveniently and widely used to describe new and useful improvements in technology.

What is claimed:

1. A bicycle frame for a tall bike, the frame comprising:
an upwardly-tilted quadrilateral frame portion comprising a rearwardly-angled head tube, a rearwardly-angled seat tube, an upwardly-angled top tube extending between and interconnecting the head tube and the seat tube, an upwardly-angled down tube spaced below the top tube and extending between and interconnecting the head tube and the seat tube;
a triangular rear frame portion comprising the seat tube, a seat stay, and a chain stay, the chain stay substantially horizontal or angled upwardly from horizontal;
a rear wheel attachment location at a rear vertex of the triangular rear frame portion;
a crankset attachment location on the seat tube below the top tube and above the down tube, the crankset attachment location being vertically higher than the rear wheel attachment location if the frame is upright.

2. A bicycle frame according to claim 1, wherein the seat tube lies vertically rearwardly of the down tube.

3. A bicycle frame according to claim 1, wherein the wherein the seat stay comprises a passage for a chain between the seat tube and the rear wheel attachment, and wherein the chain stay comprises a passage for a chain between the seat tube and the rear wheel attachment.

4. A bicycle frame according to claim 1, wherein the seat tube and the head tube are parallel to one another.

5. A bicycle frame according to claim 1, wherein the seat tube is located forwardly of a rear wheel if a rear wheel is attached to the rear wheel axis.

6. A bicycle frame according to claim 3, wherein the chain stay comprises a pair of diverging arms, and the seat stay comprises a pair of diverging arms.

7. A bicycle frame according to claim 6, wherein the top tube and the head tube comprise a forward frame junction at a highest point of the quadrilateral portion of the frame.

8. A bicycle frame according to claim 7, further comprising a seatpost extending from the seat tube above the top tube, the seatpost terminating at a height from the ground less than a height of the forward frame junction if the bicycle frame is upright.

9. A bicycle frame according to claim 1, wherein the crankset attachment point is located on a forward leg of the triangular rear frame below an apex of the triangle.

10. A bicycle frame according to claim 1, wherein the head tube and the seat stay are aligned and at the same angle relative to the chain stay.

11. A tall bike comprising a frame, a front wheel, a rear wheel, and a crankset, wherein:
the frame comprises an upwardly-tilted quadrilateral frame portion comprising a rearwardly-angled head tube, a rearwardly-angled seat tube, an upwardly-angled top tube extending between and interconnecting the head tube and the seat tube, an upwardly-angled down tube spaced below the top tube and extending between and interconnecting the head tube and the seat tube;
the frame further comprises a triangular rear frame portion comprising the seat tube, a seat stay, and a chain stay, the chain stay substantially horizontal or angled upwardly from horizontal less than the down tube;
the frame further comprises a rear wheel attachment point at a rear vertex of the triangular rear frame portion, the rear wheel rotatably mounted at the rear wheel attachment point; and,
the crankset is mounted on the seat tube between the top tube and the down tube, the crankset located forward of the rear wheel, the crankset further being higher than the rear wheel attachment point.

12. A tall bike according to claim 11, wherein the bicycle comprises a chain running between the seat tube and the rear wheel attachment to connect the crankset to the rear wheel, wherein the seat stay comprises a passage for the chain between the seat tube toward the rear wheel attachment, and wherein the chain stay comprises a passage for the chain between the seat tube toward the rear wheel attachment, and wherein the chain passes through the seat stay passage and the chain stay passage between the rear wheel attachment and the seat tube.
